(19) United States
(12) Patent Application Publication
(10) Pub. No.: US 2008/0055312 A1
(43) Pub. Date: Mar. 6, 2008

(54) Dynamic Monitoring System with Polychromatic Gradient - DMSPG

(76) Inventor: Jose Juan Sanchez, Sao Paulo (BR)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/843,537

(22) Filed: Aug. 22, 2007

(30) Foreign Application Priority Data
Aug. 25, 2006 (BR) PI 0603718-6

(51) Int. Cl. G06T 11/20

(52) U.S. Cl. 345/440.1; 345/418

(57) ABSTRACT

Dynamic Monitoring System With Polychromatic Gradient—DMSPG concerns a mechanism of visual monitoring by any visual analog or digital representation means, based on a color scale in the form of a polychromatic gradient, that is, a gradated scale. This color presentation is present in the background and its real-time variation is integrally related to the references established by the user or automatically by the system in the foreground. It may be applied to the financial market to monitor the variability of stock-exchange listings of a particular kind (stock, good, etc.) in real time or historically. It may also be applied to general monitoring systems, for example, industrial monitoring systems (boiler or tank temperature control, etc.).

### RELATED APPLICATION

This application claims priority under 35 U.S.C. § 119 or 365 to Brazil, Application No. PI 0603718-6, filed Aug. 25, 2006.

The entire teachings of the above application is incorporated herein by reference.

### BACKGROUND OF THE INVENTION

Various monitoring systems exist. For example, in financial industries, there are systems that monitor the variability of stock-exchange listings. In industrial settings, there are systems (e.g. controllers) that monitor mechanical or physical properties such as boiler temperature or tank temperature and/or pressure.

Improvements in the visual presentation of monitors (output thereof) is desired.

### SUMMARY OF THE INVENTION

This invention concerns a mechanism of visual monitoring by any visual analog or digital means, based on a color scale in the form of a polychromatic gradient, that is, a gradated scale. This color presentation will be present in the background and its variation, in real time, will be integrally related to the references established by the user or automatically by the system in the foreground.

These references are: variability margin overlaid on the graph (line graph, candlestick graph, etc.) measured by two baselines/values, maximum and minimum, as well as a mobile reference line which may or may not be coupled to the aforementioned margin.

The laws governing the background color change dynamic are applied in real time to any type of digital data, whether this comes from a digital or analog source, by means of analog-digital converters, and will be described below in the scope of the project. The monitoring system in question may be applied to the financial market to monitor the variability of stock-exchange listings of a particular kind (stock, goods, etc.) in real time or historically. It may also be applied to general monitoring systems, for example, industrial monitoring systems (boiler or tank temperature control, etc.).

Embodiments of the present invention present a Dynamic Monitoring System With Polychromatic Gradient—DMSPG, with the aim of providing a mechanism of visual monitoring by any means of analog or digital presentation, characterized in that it is based on the electronic processing of data generated by analog or digital sources constituted by analog data sources, digital data sources, other digital sources, by means of analog-digital and/or digital-digital converters. In the invention system, data is prepared, inserted, and synchronized through a data equalizer in a single signal used to feed the DMSPG server organizing a database feeding the DMSPG user in real time, which is responsible for the visual color display. The DMSPG user comprises an analysis and display program with mathematic algorithms and tables controlling the graph data and screen colors both in the foreground and background.

The basic visual monitoring components comprise: a background, with polychromatic gradient colors and/or a single color, horizontal and vertical scales within an analyzed period (axis t—time), a variable vertical axis being studied, a mobile reference line (horizontal), and a graph with various presentations in the foreground. A semi-transparent or transparent region is overlaid on the graph screen and referred to as the box or variability margin limiting the screen to specific analysis zones by maximum and minimum baseline/values. This makes it possible to place the reference axis inside the box or with the box accompanying the linked mobile reference line, a polychromatic reference band (vertical band) which can be altered by the system or operator/user linked to the margin/box under analysis.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a monitoring system embodying the present invention.

FIG. 2 is a graph of background polychromatic gradient over time used by embodiments of the present invention.

FIGS. 3-6 are example screen views generated by embodiments of the present invention.

FIG. 4 is an example screen view in which difference of dot value in relation to the invention reference line is small.

FIG. 5 is a screen view in which difference of dot value in relation to the reference line is considerably positive.

FIG. 6 is a screen view in which difference of dot value in relation to the reference line is considerably negative.

FIG. 7 is a block diagram of computer client, server, nodes or modules executing embodiments of the present invention.

### DETAILED DESCRIPTION OF THE INVENTION

A description of example embodiments of the invention follows.

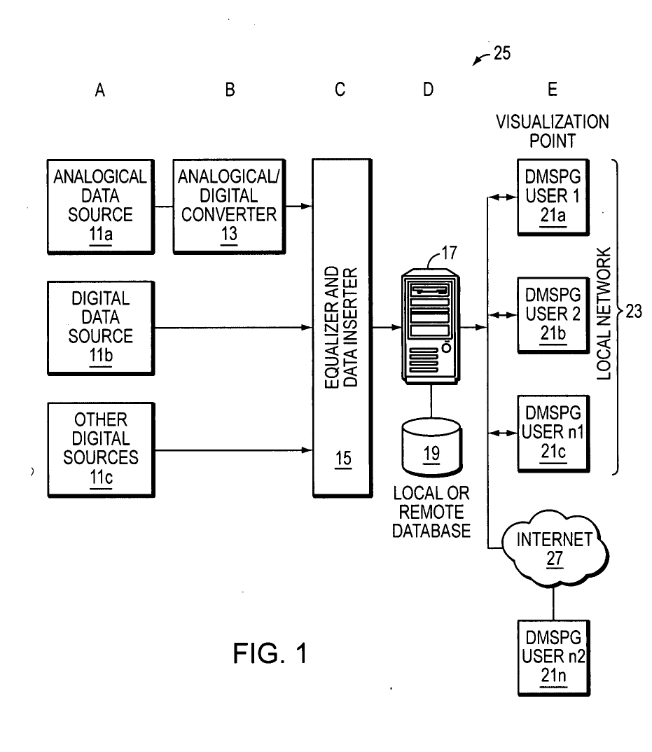

The system 25 proposed herein will be better understood with the illustration of the universal connection diagram contained in FIG. 1, where the letter “A” represents the electronic processing of data generated by analog or digital sources 11a, b, c; the letter “B” represents the data prepared by analog-digital converters 13 and/or digital-digital converters; the letter “C” represents the data from sources already prepared, inserted, and synchronized, from a data equalizer 15, in a single signal, used to feed the DMSPG server 17 organizing a database 19 defined by the letter “D.” This data feeds the DMSPG user computers/nodes 21a, 21b, 21c . . . 21n in real time represented by the letter “E.” Computer nodes 21 may be arranged in a local area network 23 or communicate over a global computer network 27 or the like. In one configuration, a client 21-server 17 architecture is employed but the invention is not limited to such.

Data sources 11 generate analogue data, digital data and/or other digital signals. Analogue-to-digital converter 13 converts the analog data to digital feed to equalizer 15. Also the source digital data and signals (from A) feed into equalizer 15. Equalizer 15 prepares, inserts and synchronizes the received data (from A and B). Equalizer 15 outputs the processed data as a single signal input to server 17.

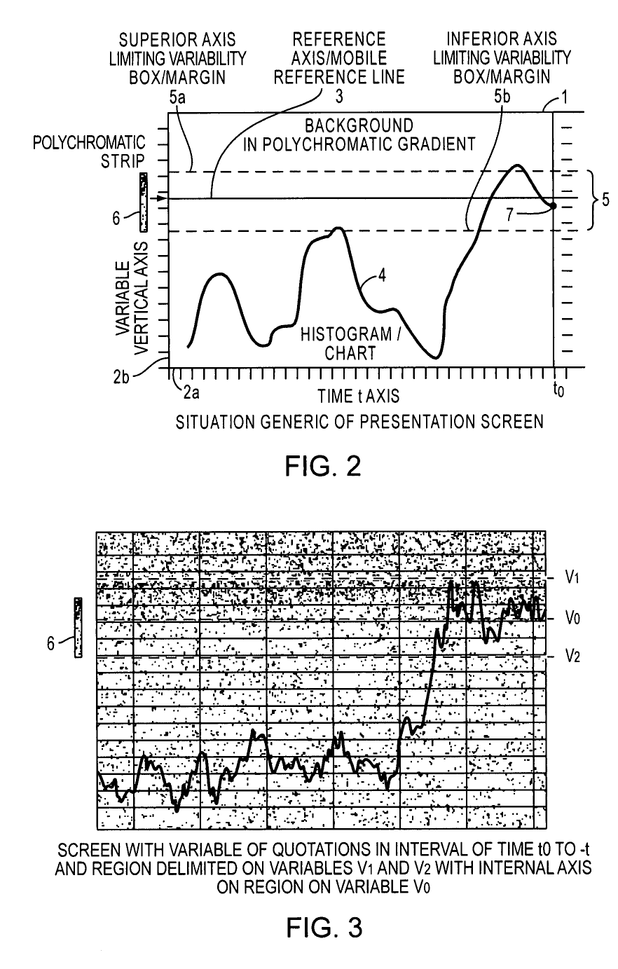

Server 17 stores the received signal data in database 19. In cooperation with user computer nodes/clients 21, server 17 and database 19 support a real-time visual color display having dynamic polychromatic gradient coloring corresponding to a reference line 3 (FIG. 2 discusses later). That is the signal data from server 17 and databases 19 to end user computer modules 21 are utilized to generate screen views or presentations of data with a gradated color scale that varies in real time with respect to a reference line. The reference line may be system defined and/or user defined. The resulting display or presentation of system screen views (rendering visual representations of the source data) provides or enables an improved visual monitoring system.

The Following is a Description of the DMSPG User System 21:

The invention system 25 comprises an analysis and display program with mathematical algorithms and tables controlling the graph data (representations of source data A) and colors of the end user display screen views both in the foreground and the background.

The basic components of the visual presentation are defined in:
1) the background 1, with colors in polychromatic gradient (gradated) and/or a single color;
2) horizontal and vertical scales within the analyzed period—t-time axis 2a, variable vertical axis 2b subject to study;
3) mobile reference line (horizontal) 3;
4) graph 4 with various presentations, line/dot, dot-to-dot, dashed, bar, candlestick, etc. in the foreground (foreground histogram);
5) semi-transparent or transparent region, overlaid on the graph screen, referred to as a box or variability margin 5, limiting the screen to specific zones of analysis by maximum and minimum baseline/values 5a, 5b making it possible to place the reference axis (the mobile reference line) 3 inside the box or with the box accompanying the linked mobile reference line;
6) polychromatic reference band (vertical band) 6, which can be changed (color spectrum) by the system or by the operator/user, linked to the analysis margin/box 5. The purpose of this is to reference the gradated color changes (gradient) of the background 1.

Description of the Polychromatic Dynamic in the Background:

The background 1 colors variability is regulated by the position/value relationship with the mobile reference line (3) illustrated in FIG. 2. This relationship is measured as a variation percentage and is applied to the variability margin (5), which in turn is linked to the polychromatic band (6) affecting the change of background colors. The lower the variability margin 5, the faster the change in background 1 colors using the polychromatic band 6; however, the higher the variability margin 5, the greater the differences have to be between the reference line 3 and subject data point or dot 7 to provoke a change in the background colors and is therefore slower than the polychromatic variation in the background 1. The color rules in application are governed by the relationship between the polychromatic band (6) and the mobile reference line (3).

Furthermore, the gradated or polychromatic color gradient used in the background (1) as a variability indicator and therefore governed by the polychromatic band, is based on a color spectrum with a variability governed by the colors present in the polychromatic band 6 (see FIG. 2). This spectrum may be composed of various colors starting with one tone and ending with a different one (gradated), or even being made up of a single color (single-color gradation).

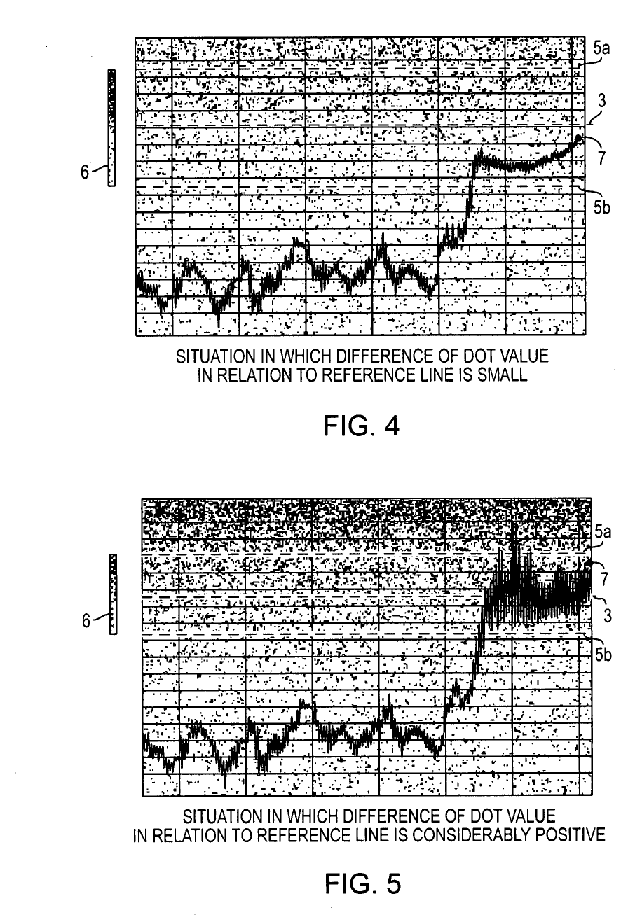

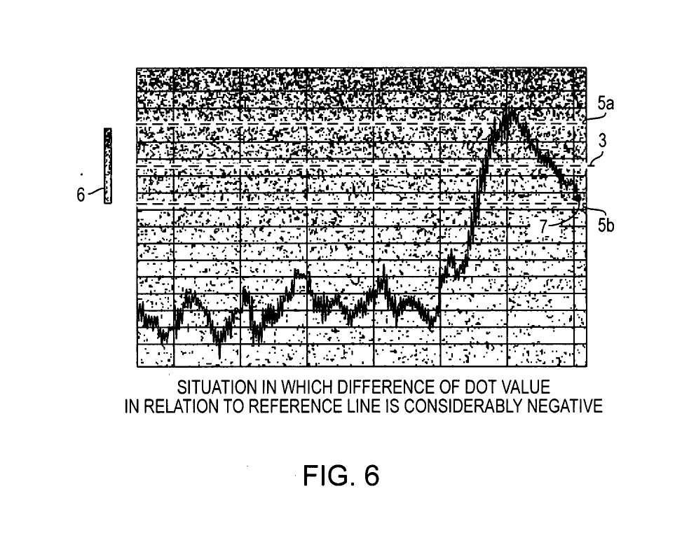

With a view to a better explanation of this system 25, some examples of embodiments are provided below, wherein FIG. 3 shows the screen with subject quotation listings variable in the time period equal to t₀ to -t and the region marked out in variables V₁ and V₂ with an internal axis in the region indicated at variable V₀. FIG. 4 represents a situation whereby there is a small difference in value between the subject dot 7 and the reference line 3; FIG. 5 represents a situation whereby the difference in value between the subject dot 7 and the reference line 3 is considerably positive; and FIG. 6 represents a situation whereby the difference in value between the dot 7 and the reference line 3 is considerably negative.

Although only those illustrations contained in FIGS. 3, 4, 5, and 6 have been presented, there are however countless possible applications for this system 25 as long as there is a variable to be monitored in relation to a predetermined reference. The system will present the gradated colors on the screen, enabling the operator to take the necessary measures in the event that the variable reaches incorrect or undesirable values.

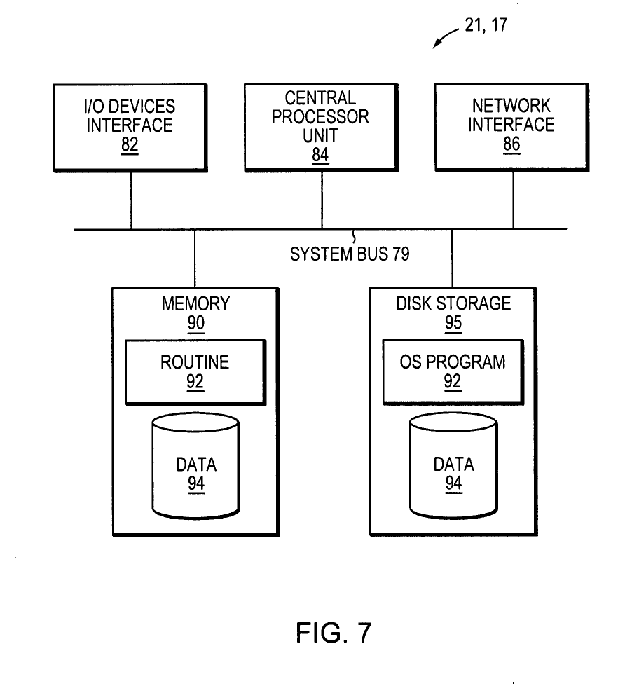

FIG. 7 is a diagram of the internal structure of a computer (e.g., client processor/device 21 or server computers 17) in the computer system 25 of FIG. 1. Each computer 17, 21 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 21, 17. Network interface 86 allows the computer to connect to various other devices attached to a network (e.g., network 23, 27 of FIG. 1). Memory 90 provides volatile storage for computer software instructions 92 and data 94 used to implement an embodiment of the present invention (e.g., program tables, polychromatic gradient band 6, variability margin 5, mobile reference line 3, background color and change in color rules, and code for controlling graph data detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 21 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a variety of computer architectures. The computer network of FIGS. 1 and 7 are for purposes of illustration and not limitation of the present invention.

1. A monitoring system comprising:
a module providing visual presentations; and
a processing member processing data generated by any of analog data sources, digital data sources, other digital sources, the processing member feeding processed data to the module, the module responsively presenting a visual color display having dynamic polychromatic gradient coloring corresponding to a reference line.

2. A monitoring system as claimed in claim 1, wherein the data is prepared, inserted, and synchronized through a data equalizer in a single signal used to feed the module providing visual presentations; and
the processing member server including a server organizing a database feeding the module in real time.

3. A monitoring system as claimed in claim 2, wherein the module further comprises an analysis and display program with mathematic algorithms and tables controlling graph data and screen colors both in the foreground and background.

4. A dynamic monitoring system as claimed in claim 1, wherein the module further comprises an analysis and display program with mathematic algorithms and tables controlling the graph data and screen colors both in the foreground and background.

5. A monitoring system as claimed in claim 1, wherein the visual color display is a screen view formed of: a background, with polychromatic gradient colors and/or a single color, horizontal and vertical scales within an analyzed period of time, a variable vertical axis being studied, a mobile reference line, a graph with various presentations in the foreground, a semi-transparent or transparent region overlaid on the graph serving as a bounding box or variability margin limiting the screen view to specific analysis zones by maximum and minimum baseline/values, making it possible to place the reference axis inside the box or with the box accompanying the linked mobile reference line, polychromatic reference band which can be altered by the system or operator/user linked to the margin/box under analysis.

6. A method of presenting a graph of data points, the method comprising:
providing a mobile reference line having at any one time a reference value;
determining a difference between the value of a given data point of the graph and the reference value of the mobile reference line;
providing a chromatic gradation as the background of the graph based on the difference.

7. A method as in claim 6 wherein providing the chromatic gradation includes providing a polychromatic gradation.

8. A method as in claim 6 wherein determining the difference includes determining a percentage difference between the value of the given data point and the reference value of the mobile reference line.

9. A method as in claim 6 wherein providing the chromatic gradation includes varying the chromatic gradation in real-time as the given data point changes.

10. A method as in claim 9 wherein varying the chromatic gradation in real-time includes varying the chromatic gradation with reference to the mobile reference line.

11. A method as in claim 6 further comprising:
providing a variability margin having a maximum value and a minimum value, and being associated with chromatic reference band; and
wherein providing the chromatic gradation includes providing a chromatic gradation based on the chromatic reference band and the difference.

12. A method as in claim 11 wherein the reference value of the mobile reference line is within the maximum and minimum values of the variability margin.

13. A method as in claim 11 wherein the magnitude of the difference needed to prompt a varying of the background gradation is proportional to the size of the variability margin.

14. A method as in claim 11 wherein providing the chromatic gradation includes varying the chromatic gradation in real-time as the given data point changes.

15. A method as in claim 14 wherein varying the chromatic gradation in real-time includes varying the chromatic gradation with reference to the variability margin.

16. A system for providing a graphical display of data points, comprising:
a data source to provide the data points;
a processor to generate a graphical representation of the data points; and
a display device to display the graphical representation of the data points, a mobile reference line having at any one time a reference value, and a background having a chromatic gradation based on a difference between the value of a given data point of the graph and the reference value of the mobile reference line.

17. A system as in claim 16 wherein the chromatic gradation is a polychromatic gradation.

18. A system as in claim 16 wherein the difference is a percentage difference between the value of the given data point and the reference value of the mobile reference line.

19. A system as in claim 16 wherein the chromatic gradation varies in real-time as the given data point changes.

20. A system as in claim 19 wherein the chromatic gradation varies in real-time with reference to the mobile reference line.

21. A system as in claim 16 wherein the display device further displays a variability margin having a maximum value and a minimum value, and being associated with a chromatic reference band; and
wherein the chromatic gradation is based on the chromatic reference band and the difference.

22. A system as in claim 21 wherein the reference value of the mobile reference line is within the maximum and minimum values of the variability margin.

23. A system as in claim 21 wherein the magnitude of the difference needed to prompt a varying of the background gradation is proportional to the size of the variability margin.

24. A system as in claim 21 wherein the chromatic gradation varies in real-time as the given data point changes.

25. A system as in claim 24 wherein the chromatic gradation varies in real-time with reference to the variability margin.
